(19) United States
(12) Patent Application Publication
(10) Pub. No.: US 2006/0200415 A1
(43) Pub. Date: Sep. 7, 2006

(54) Videonline security network architecture and methods therefor

(76) Inventor: Priscilla M. Lu, San Carlos, CA (US)

Correspondence Address: IPSG, P.C., P.O. BOX 700640, SAN JOSE, CA, 95170-0640, US

(21) Appl. No.: 11/357,777

(22) Filed: Feb. 16, 2006

Related U.S. Application Data
(60) Provisional application No. 60/654,030, filed on Feb. 16, 2005.

(51) Int. Cl. G06Q 99/00

(52) U.S. Cl. 705/50

(57) ABSTRACT

A method for transmitting a multimedia content file encrypted with a multimedia content key to a rendering device, the rendering device further including a private license key, I is disclosed. The method includes configuring a license server with a set of rights associated with the multimedia content file and with a rendering device user. The method also includes requesting that a requested right for the multimedia content file be exercised on the rendering device. The method further includes, if the requested right is included in the set of rights, encrypting the content key with a public license key, wherein the private license key is configured to decrypt the content key. The method also includes transmitting the content key to the rendering device; transmitting the multimedia content file; decrypting the multimedia content file; and rendering the multimedia content file.

### RELATED APPLICATIONS

This application claims the benefit of U.S. Ser. No. 60/654,030, filed Feb. 16, 2005, of U.S. Ser. No. 10/949,825, filed Sep. 24, 2004, and of U.S. Ser. No. 11/179,361, filed Jul. 11, 2005. All applications incorporated herein by reference and all priorities claimed.

### BACKGROUND OF THE INVENTION

The present invention relates in general to personal communication systems. More particularly, the present invention relates to a videonline security network and methods therefor.

The Internet has become an efficient mechanism for globally distributing digital content, such as movies. However, the advantage of easy digital communication has also allowed the digital content to be easily pirated by just about anyone with a computer and Internet access. The combination of high-speed broadband Internet access, digital content compression software (which reduces the size of digital content files), peer-to-peer file trading networks (which allows users to post content files), and lack of viable digital rights standards, has caused the content owners to lose control of their content. Consequently, content owners are experiencing a loss of potential revenue.

What is needed are advanced techniques for controlling the purchase and use of digital content, such that content owners are fairly compensated without discouraging buyers from purchasing the digital content.

### SUMMARY OF THE INVENTION

The invention relates to an a method for transmitting a multimedia content file encrypted with a multimedia content key to a rendering device, the rendering device further including a private license key. The method includes configuring a license server with a set of rights associated with the multimedia content file and with a rendering device user. The method also includes requesting that a requested right for the multimedia content file be exercised on the rendering device. The method further includes, if the requested right is included in the set of rights, encrypting the content key with a public license key, wherein the private license key is configured to decrypt the content key. The method also includes transmitting the content key to the rendering device; transmitting the multimedia content file; decrypting the multimedia content file; and rendering the multimedia content file.

The invention relates to an a method of transmitting a multimedia content file encrypted with a multimedia content key to a rendering device, the rendering device further including a private license key. The method includes configuring a license server with a set of rights associated with the multimedia content file and with a rendering device user. The method also includes requesting that a requested right for the multimedia content file be exercised on the rendering device. The method further includes, if the requested right is included in the set of rights, encrypting the content key with a public license key, wherein the private license key is configured to decrypt the content key. The method also includes, if the requested right is not included in the set of rights, billing the rendering device user for the requested right and encrypting the content key with the public license key. The method further includes adding a watermark to the multimedia content file; transmitting the content key to the rendering device; transmitting the multimedia content file; decrypting the multimedia content file; rendering the multimedia content file.

The invention relates to an apparatus for transmitting a multimedia content file encrypted with a multimedia content key to a rendering device with a smart key, the rendering device further including a private license key. The apparatus includes means of configuring a license server with a set of rights associated with the multimedia content file and with a rendering device user. The apparatus also includes means of requesting that a requested right for the multimedia content file be exercised on the rendering device. The apparatus further includes, if the requested right is included in the set of rights, means of encrypting the content key with a public license key, wherein the private license key is configured to decrypt the content key. The apparatus also includes, if the requested right is not included in the set of rights, means of billing the rendering device user for the requested right and encrypting the content key with the public license key. The apparatus further includes means of adding a watermark to the multimedia content file; means of transmitting the content key to the rendering device; means of transmitting the multimedia content file; means of decrypting the multimedia content file; and means of rendering the multimedia content file.

These and other features of the present invention will be described in more detail below in the detailed description of the invention and in conjunction with the following figures.

### BRIEF DESCRIPTION OF THE DRAWING

The present invention is illustrated by way of example, and not by way of limitation, in the figures of the accompanying drawings and in which like reference numerals refer to similar elements and in which:

FIG. 1 shows a simplified diagram of a process for encrypting a multimedia file, according to an embodiment of the invention;

FIG. 2 shows a simplified diagram of a secured multimedia digital content delivery architecture, according to an embodiment of the invention;

FIG. 3 shows a simplified diagram of a multimedia digital content stream, according to an embodiment of the invention; and

FIG. 4 shows a simplified diagram of a method for transmitting a multimedia content file encrypted with a multimedia content key to a rendering device, according to an embodiment of the invention.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

It is believed by the inventor herein that a digital rights management (DRM) scheme may be implemented, such that a digital multimedia content may be substantially protected by first securely transmitting a content key (CKey) to a trusted digital content rendering device (rendering device), and then transmitting a digital multimedia content encrypted with the CKey to that rendering device. Consequently, the digital multimedia content stream may then be securely played by an authorized user. In an embodiment the digital multimedia content is transmitted as stream. In an embodiment the digital multimedia content is transmitted as a file. In an embodiment, the digital multimedia content is rendered on a DRM player. In an embodiment, the rendering device includes a license manager. In an embodiment, the license manager is integrated with the DRM player as a single application. In an embodiment, the license manager is separate from the DRM player. In an embodiment, the license manager is implemented using a separate processor, such as with a smart key.

As previously described, content owners may experience a loss of potential revenue because of the lack of viable digital rights standards. By some estimates, the loss is about $5 billion a year. However, protecting digital rights should not discourage user purchases of digital content. A strongly designed DRM system that is poorly implemented may protect content, but it may also discourage utilization and hence also cause the loss of revenue. The present invention advantageously combines a strong DRM system with an intuitive and easy user interface, such that utilization is encouraged. In an embodiment, Microsoft, DIVX, Real and other industry supported DRM are supported.

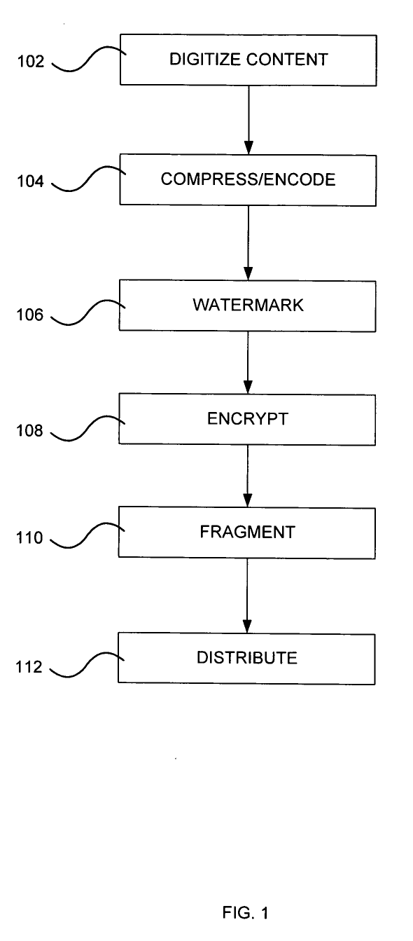

Referring now to FIG. 1. a simplified diagram showing a process for encrypting a multimedia file is shown, according to an embodiment of the invention. Initially, at 102 the multimedia content, typically including a video portion and an audio portion, is digitized normally in an uncompressed format, such as uncompressed AVI, uncompressed MOV, etc.

At 104, the digital multimedia content is encoded and further compressed into the transmission format MPEG (1, 2, 4, etc.), audio (MP3, AAC), JPEG, WMA, RM, compressed AVI, etc. To compress video, for example, a complex mathematical formula breaks the video into individual frames. Each frame is broken into moving and static components. Compression software takes each moving object and guesses where it will be in the next frame. By refreshing only the moving components of a frame, and recycling the static, compression reduces the size and transmission time of the video file. In general, three factors that make up the quality of the video portion: frame rate, color depth and resolution.

Frame rate is generally the number of still images that make up one second of a moving video image. At 30 frames per second (fps), images seem to move fluidly and naturally. However, if the video is going to be rendered on a relatively low bandwidth device, a lower frame rate, such as 10 fps, may be chose. An alternative technique may be a slideshow, in which the frame rate may be limited to one frame every five seconds.

Color depth is generally the number of bits of data the computer assigns to each pixel of the frame. When there are more bits of data assigned to color each pixel, there are more colors that can be emulated on the screen. In general, most video may encoded with 8-bit 256 color, 16-bit 64,000 color, or 24-bit 16.8 million colors. However, since greater color depth may increase the size of the streaming file, 8-bit or 16-bit is preferred.

Resolution is typically a measure of the number of pixels. The greater the number of pixels, the higher the resolution of the video. For example, if your video is 640×480, you have 640 pixels across each of the 480 vertical lines of pixels. Streamed video ranges in resolution from postage-stamp size (49×49 pixels) to 640×480 and beyond, which is considered full-screen video.

At 106, a watermark is added to the digital multimedia content in order to determine it origin, such as a particular distribution channel or network (e.g., Comcast, Cingular, China Telecom, etc.). In an embodiment, the watermark is added to the audio portion of the digital multimedia content. In an embodiment, the watermark is added to the video portion of the digital multimedia content.

At 108, in an advantageous manner, the multimedia digital content is then encrypted with a particular CKey, for example using a symmetric block-ciphering encryption, such that it cannot properly rendered without first decrypting the digital multimedia content with the CKey. In an embodiment, an audio portion of the digitized content is not encrypted. In an embodiment, the multimedia digital content is at least partially encrypted.

In general, substantially encrypting the multimedia digital content would provide the greatest protection against unauthorized decryption. However, decrypting a fully encrypted may also be substantially time consuming. Consequently, the use of a partially encrypted file may be quickly decrypted, yet still may not be rendered on a rendering device. In an embodiment, the rendering device includes a DRM enabled multimedia player (DRM player). In an embodiment, the DRM player is provided via a ViDeOnline service website.

For example, a common encryption technique involves the use of symmetric block-ciphering encryption, such AES (Rijndael), DES, Triple DES, Lucifer, Blowfish, CAST, IDEA, RC5, RC2, etc. In general, symmetric block-ciphering encryption involves dividing a plaintext M (digital multimedia content) into blocks of fixed length M=M₁, M₂ . . . M_{N}. Each message block Mi is encrypted to ciphertext block, which, in turn, is concatenated into the ciphertext message (encrypted digital multimedia content). The more times this is done, that is the more rounds, the more resistant to cryptanalysis is the ciphertext. However, in general, as the number of rounds increase, so does the decryption time at the rendering device.

With appropriate strong encryption, the inventor believes that the cost of attacking a strongly encrypted digital multimedia content would far exceed the economic value of that content. Consequently, even a partial encryption would generally provide sufficient protection of the digital multimedia content, while still allowing that content to be quickly decrypted and rendered at the rendering device. In an embodiment, a single round is used. In an embodiment, every other block is encrypted. In an embodiment, a set of blocks are encrypted based on a predetermined algorithm that is also known or transmitted to the rendering device.

Next, at 110, the encrypted digital multimedia content is fragmented at 110. In general, in order to further decrease the likelihood that the digital multimedia content is compromised, and to facilitate bandwidth and load balancing during playback, the digital multimedia content file is divided in a set of sub-parts using a predetermined algorithm. Each of those sub-parts may then be distributed among a set of content management servers, at 112. Consequently, in response to an authorized request to transmit the multimedia digital content, each of the sub-parts would be properly assembled and transmitted to the requestor's rendering device. A table may be employed to trace the sub-parts and their location for subsequently assembly.

However, if one of the content management servers is compromised, only a portion of the sub-parts may be obtained. In general, the value of digital multimedia content (e.g., movie, etc.) is substantially related to its complete renderability. For example, few users would be interested in seeing only every third minute of a movie. In an embodiment, the digital multimedia content is fragmented into a set of substantially symmetric sub-parts. That is, each of the sub-parts is of the same size. In an embodiment, the digital multimedia content is fragmented into a set of asymmetric sub-parts. In an embodiment, the sub-parts may be interwoven into the original digital multimedia content file after an authorized request is received.

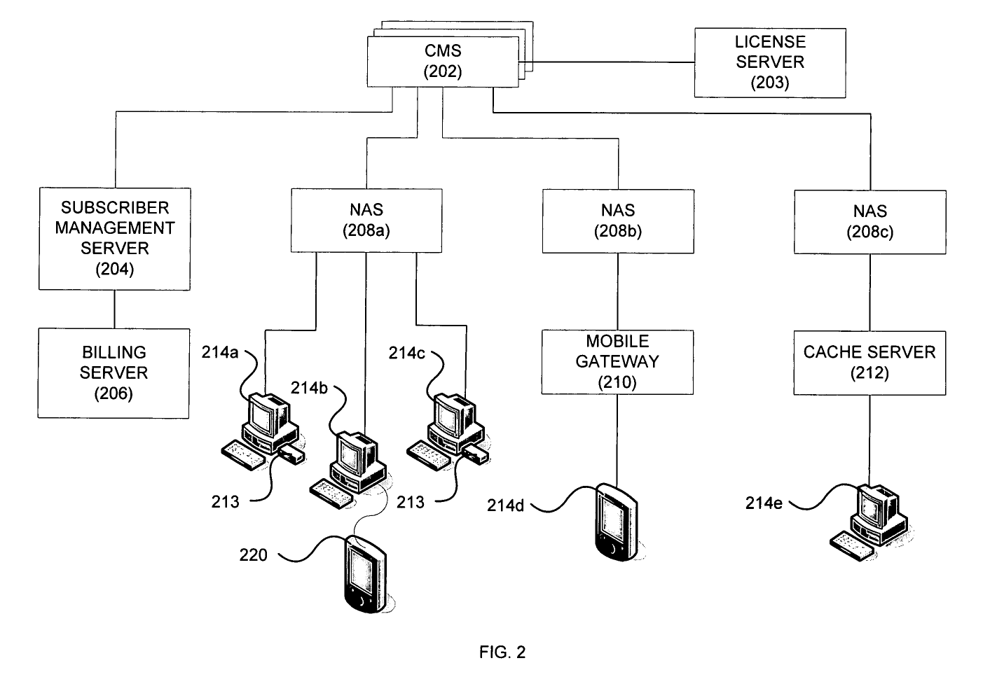

Referring now to FIG. 2, a simplified diagram of a secured multimedia digital content delivery architecture, according to an embodiment of the invention. As previously described, each encrypted digital multimedia content file is generally fragmented into a set of sub-parts, which are subsequently stored in a distributed manner on a set of content management system servers 202 (CMS). In an embodiment, the set of CMS servers 202 are coupled together in a secured peer to peer network, such that each may request any required sub-parts from the secured peer to peer network in order to first assemble, and then securely transmit a multimedia digital content file. In addition, a license server 203 may also be coupled to CMS servers 202. License server 203 is commonly configured to verify user rights with respect to specific multimedia digital content, authorize new access, and revoke access.

As previously described, rendering devices 214 may be configured with a DRM player. In general, a rendering device may be any device capable of running a DRM player, a license manager, a user interface for rendering the particular multimedia digital content (e.g., personal computer, laptop, MS Windows Mobile device, Palm device, etc.), and direct or indirect network access to CMS servers 202 and licensing server 203.

Commonly, rendering devices 214a-c are coupled to some type of network access server (NAS) 208. NAS is typically a computer server that enables an independent service provider (ISP) (e.g., Comcast, China Telecom, Cingular, etc.) to provide connected customers with Internet access. NAS 208 generally has interfaces to both the local telecommunication service provider such as the phone company and to the Internet backbone. Typically, NAS 208 authenticates users requesting login, performing the necessary steps to authenticate and authorize each user, usually by verifying a user name and password, and then allows requests to begin to flow between the user host and hosts (computers) elsewhere on the Internet. NAS 208 may be further configured to provide a host of services such as VoIP, etc.

In an embodiment, rendering devices 214a is further configured with smart key 213, such as a USB smart key, or any other processor-driven smart-key-type device that may be implemented using any protocol for I/O. Smart key 213 is generally a security authorization storage device configured to move authorizations from one rendering device 214a to another 214c. In general, if a smart key is used, an additional session key (SKey) is transmitted with the CKey, as previously described, in order to for that particular rendering device 214c to decode and render the digital multimedia content file. Generally, the SKey is tied to a unique identifier on the smart key, such that a combination of the CKey, the SKey is required to decode and render the digital multimedia content file. For example, if a user moves a smart key from rendering device 214a to rendering device 214c, rendering device 214a can no longer render the digital multimedia content file, whereas rendering device 214c may render the digital multimedia content file.

In another configuration, a mobile rendering device 214d (e.g., mobile phone, Windows ME wireless device, Palm wireless device, etc.) is first coupled to a mobile gateway 210, which is in turn coupled to NAS 208. Mobile gateway 210 is generally configured to enable mobile devices that are not directly compatible with the Internet, to access resources on the Internet. For example, mobile gateway 210 may serve as the interface between NAS 208 and a micro browser in the mobile rendering device 214d, performing translations between HTML, HDML and WML coming from the Web.

In an alternate configuration, rendering devices 214 may be directly coupled to a cache server 212 that locally stores the multimedia digital content, for example for use in a kiosk. In general, cache server 212 securely stores the requested multimedia digital content locally, and also sends the multimedia digital content to rendering device 214e. The next time cache server 212 gets a request for the same multimedia digital content, it simply returns the locally cached data instead of retrieving the content from a CMS server 202, thus reducing Internet traffic and response time

In addition, a rendering device with a DRM player, such as rendering device 214b, may also function as a trust proxy for other devices 220 that do not directly (indirectly) access the network, yet are still capable of rendering the particular multimedia digital content. In this instance, secured rendering device 214b would manage the authentication and authorization process for device 220, request that the multimedia digital content be securely transferred to secured rendering device 214b, and then transfer the multimedia digital content to device 220.

In a common configuration, a user desires to render (e.g., view, listen, etc.) a particular multimedia digital content file. The user would log on to a secured rendering device 214a, and then be authenticated by the license manager. The license manager would, in turn, access a CMS server 202 in order to determine the user's then current rights. For example, the user may have the right to render on a particular rendering device 214 (e.g, DRM player, a Windows ME device, a Palm OS device, and a personal computer, etc.), the right to render before a particular end date, the right to render for a specified number of times, the right to render on a specified number of rendering devices 214a-e, the right to render in a specified resolution, the right to render if obtained through a specified distribution channel, etc. In an embodiment, an owner of the multimedia digital content may dynamically change the ability of a multimedia digital content file to be rendered on a particular rendering device, from a particular origin, or by a specific user.

If sufficient rights exist, then the user is authorized to render the multimedia digital content in rendering device 214a. If the content is locally stored, the user may immediately begin rendering (e.g., viewing a movie, listening to a song, etc.). If the content is not locally stored, the DRM player requests that license server 203 authorizes CMS server 202 to transmit the content to rendering device 214a.

If sufficient rights do not exist, but may be obtained, then the user is given an option to obtain those rights. For example, if a multimedia digital content file has already been licensed for a set number of rendering devices (e.g., home PC, work laptop, Windows ME device, etc.), the user may be given the option of disabling a previously authorized rendering device, in order to enable current rendering device 214a. Likewise the user may be given the option of purchasing another license to render the multimedia digital content file.

For example, a user may want to purchase the right to play a movie on rendering device 214a. The license manager installed on rendering device 214a would contact license server 203, through NAS 208a, requesting authorization. License server 203 would, in turn, contact the appropriate ISP's subscriber management server 204 in order to request that the user be billed for the movie. Subscriber management server 204 then would contact billing server 206 to initiate a charge that may appear on the user's bill. If the charge is successful, subscriber management server 204 informs license server 203, which in turn, authorizes a CMS server 202 to begin to transmit the movie to rendering device 214a.

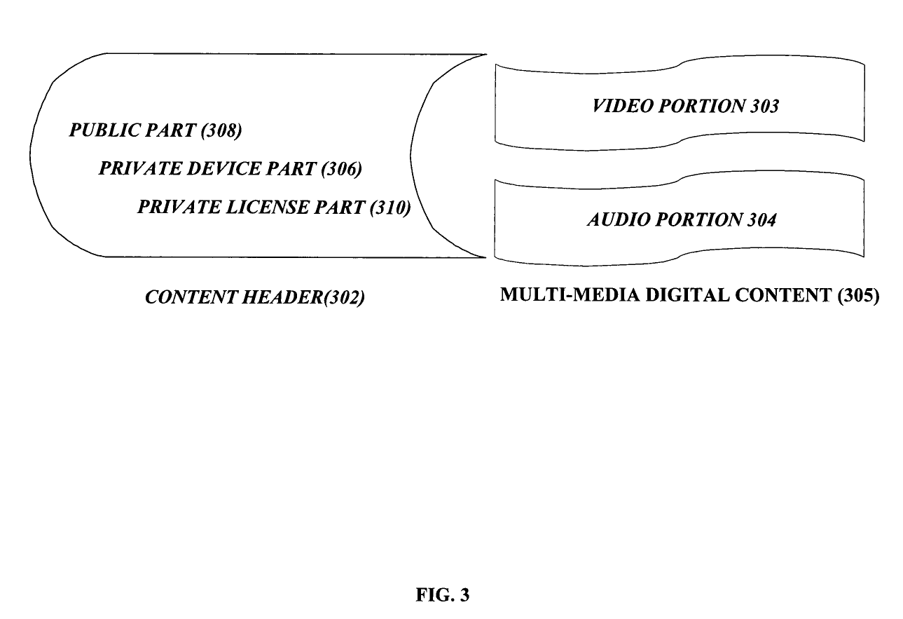

Referring now to FIG. 3, a simplified diagram of a multimedia digital content stream is shown, according to an embodiment of the invention. As previously described, a multimedia digital content 305 is encrypted with a particular CKey, using a symmetric block-ciphering encryption, as well as being watermarked in order to determine origin. Prior to being transmitted to rendering device 214, additional security indicia may be added to the watermark, for example, a rendering device ID, a user ID, transmission timestamp, etc.

Consequently, if the multimedia digital content file is compromised, stripped of DRM protection, and made publicly available on the Internet, the source of the compromised file may still be determined from the watermark. In an embodiment, the watermark may be added to an audio portion 304 of multimedia digital content file 305. In an embodiment, the watermark is periodically repeated in the audio portion 304 multimedia digital content file. In an embodiment, the watermark may be added to a video 303 portion of multimedia digital content file 305. In an embodiment, the watermark is periodically repeated in video portion 303 of multimedia digital content file 305.

In addition, a content header 302 is also generated and added to multimedia digital content file 305 including a public part 308, a private device part 306 and a private license part 310. Public part 308 generally includes unencrypted identification information that may be access by anyone, such as content ID, content description, copyright information, service URL, user readable DRM information, etc. In general, this information may be displayed in the DRM player. For example, if a user attempts to render multimedia digital content file 104 without authorization, the user would still be able to view public part 308 of content header 302.

Private device part 306 generally includes an encrypted CKey, as well as an optional SKey if a smart key is used. In general, the CKey is encrypted with a set of public key infrastructure (PKI) keys and unique IDs that are issued or stored by the license server [not shown], such as media content ID, the device ID, the user's personal identification code (PIC), a transaction ID, etc.

Media content ID is a unique identifier assigned to the particular multimedia digital content file. Device ID is a unique identifier assigned to the particular rendering device that is registered with the license server. PIC is a unique identifier identifying a user for billing and DRM purposes. Transaction ID is a unique identifier assigned to the specific purchase transaction associated with the particular multimedia digital content file.

Private license part 310 generally includes specific rights and limitation for the specific multimedia digital content file 305, and is considered a complete license. Private license part 310 may include information related to the DRM attributes for the multimedia digital content file, and is generally used by the license manager to validate access to the multimedia digital content file, such as transaction type (e.g., purchase, rental, etc.), transaction specifics associated with that transaction type (e.g., end date, number of plays, etc.), a unique transaction key (TKey) associated with the transaction type, etc. In general, the TKey is uniquely generated for each issued multimedia digital content file license. Typically, private license part 310 is encrypted using the public key of the license manager. For example, if the user has purchased a multimedia digital content file 305, the number of plays may be unlimited. However, if a user rents multimedia digital content file 305, the number of plays may be limited, or the time in which to view the multimedia digital content file 305 is limited.

In general, PKI key cryptography, as used in this invention, is based on the use of key pairs. When using a key pair, only one of the keys, referred to as the private key, must be kept secret and (usually) under the control of the owner. The other key, referred to as the public key, can be disseminated freely for use by any person who wishes to participate in security services with the person holding the private key. This is possible because the keys in the pair are mathematically related but it remains computationally infeasible to derive the private key from knowledge of the public key. In an embodiment, the license server stores both a private and public key pair for each issued or used PKI key.

After multimedia digital content file 305 has been authorized for transmission to a rendering device [not shown], the content header 302 is generated. In an embodiment, private license part 310 is delivered when the download occurs. In an embodiment, private license part 310 is delivered at a later time when a user wishes to access the multimedia digital content file.

For example, when the user requests a DRM license for a multimedia digital content file, a content ID of the requested content file may be retrieved. Next, a unique T-Key may be created. A symmetric key may then be created by combining the content ID, device ID, PIC, and T-Key. The previously generated C-Key, used to encrypt the multimedia digital content file, may then be retrieved and encrypted using the symmetric key. The private license part may then also be encrypted using the public key of the license manager in the device, and subsequently passed to the DRM player.

When the user accesses the content in his DRM player, the license may be verified by the license manager by first opening the private license part using the DRM player's private key. Next, the business roles in the license may be interrogated in order to validate the user's right to access the content. If the license is valid, the license manager may extract the T-Key from the license for use by the DRM player. If the license is validated, the DRM player may use the content ID, the T-Key, the device ID and the PIC, in order to decode the C-Key and render the multimedia digital content file.

If a smart key is used, the process may be modified. For example, when the user requests a DRM license for a multimedia digital content file, a content ID of the requested content file may be retrieved. Next, a unique T-Key and S-Key may be created. A symmetric key may then be created by combining the content ID, device ID, PIC, and T-Key. The previously generated C-Key, used to encrypt the multimedia digital content file, may then retrieved and encrypted using the symmetric key for each registered device and stored in an array in the private device part. The private license part may then also be encrypted using the public key of the license manager in the device, and subsequently passed to the DRM player.

When the user accesses the content in his DRM player, the user generally must generally plug the smart key into the USB port of the rendering device. The DRM player may then pass to the license manager in the smart key the content ID of the multimedia digital content file to be played. The license manager, in turn, may then verify the license by first opening the private license part using the public key of the license manager; interrogating the business roles in the license to validate the user's right to access the content; and if the license is valid, the extracting the T-Key for use by the DRM player. The license manager may then encrypt the T-Key using the S-Key in the license and passes it back to the player. The DRM player may then decrypt the T-Key using the S-Key, and may subsequently use the content ID, the T-Key, the device ID and the PIC, in order to decode the C-Key and render the multimedia digital content file.

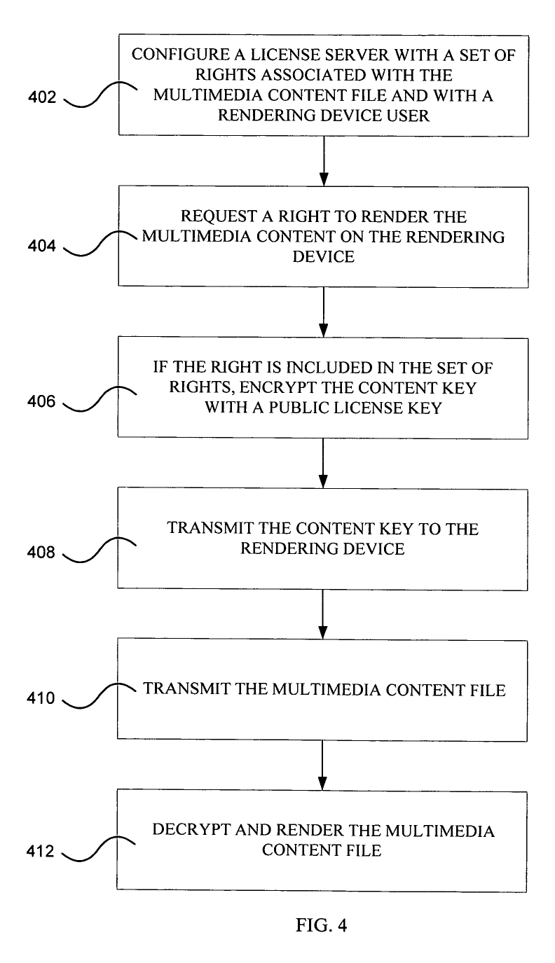

Referring not to FIG. 4, a simplified diagram of a method for transmitting a multimedia content file encrypted with a multimedia content key to a rendering device, the rendering device further including a private license key, is shown, according to an embodiment of the invention. Initially, at 402, a license server is configured with a set of rights associated with the multimedia content file and with a rendering device user. Next at 404, a right to render the multimedia content on the rendering device is requested. Next at 406, if the right is included in the set of rights, the content key is encrypted with a public license key, wherein the private license key is configured to decrypt the content key. Next at 408, the content key is transmitted to the rendering device. Next at 410, the multimedia content file is transmitted. Finally at 412, the multimedia content file is decrypted and rendered.

While this invention has been described in terms of several preferred embodiments, there are alterations, permutations, and equivalents which fall within the scope of this invention.

Advantages of the invention include a videonline security network architecture and methods therefore. Additional advantages include the ability to control the purchase and use of digital content, such that content owners are fairly compensated without discouraging buyers from purchasing the digital content.

Having disclosed exemplary embodiments and the best mode, modifications and variations may be made to the disclosed embodiments while remaining within the subject and spirit of the invention as defined by the following claims.

What is claimed is:

1. A method for transmitting a multimedia content file encrypted with a multimedia content key to a rendering device, said rendering device further including a private license key, comprising;
configuring a license server with a set of rights associated with said multimedia content file and with a rendering device user;
requesting that a requested right for said multimedia content file be exercised on said rendering device;
if said requested right is included in said set of rights, encrypting said content key with a public license key, wherein said private license key is configured to decrypt said content key;
transmitting said content key to said rendering device;
transmitting said multimedia content file;
decrypting said multimedia content file;
rendering said multimedia content file.

2. The method of claim 1, wherein said set of rights includes one of the right to render, the right to render before an end date, a right to render for a specified number of times, a right to render on a specified number of rendering devices, a right to render in a specified resolution, and a right to render if obtained through a specified distribution channel.

3. The method of claim 2 further including the step of if said requested right is not included in said set of rights, billing said rendering device user for said requested right and encrypting said content key with said public license key, before said step of transmitting said content key to said rendering device.

4. The method of claim 3, wherein said multimedia content file includes one of an audio portion and a video portion.

5. The method of claim 4, further including the step of adding a watermark to at least one of said audio portion and said video portion before said step of transmitting said content key to said rendering device.

6. The method of claim 5, wherein said multimedia content file is encoded using one of MPEG 1, MPEG 2, MPEG 4, MP3, AAC, JPEG, WMA, RM, and compressed AVI.

7. The method of claim 6, wherein said multimedia content file is encrypted with one of AES, DES, Triple DES, Lucifer, Blowfish, CAST, IDEA, RC5, and RC2.

8. The method of claim 7, wherein said rendering device is one of a DRM player, a Windows ME device, a Palm OS device, and a personal computer.

9. The method of claim 8, wherein said multimedia content file is fragmented into a plurality of multimedia content file parts.

10. The method of claim 9, wherein said plurality of multimedia content file parts is stored on a set of content management servers.

11. The method of claim 10, wherein said set of content management servers are coupled to a peer to peer network.

12. The method of claim 11, wherein said rendering device includes a smart key.

13. The method of claim 12, wherein a content ID is associated with said multimedia content file.

14. The method of claim 13, wherein a device ID is associated with said rendering device.

15. The method of claim 14, wherein a personal identification code is associated with said rendering device user.

16. The method of claim 15, wherein a transaction key is associated with a purchase of said set of rights.

17. The method of claim 16 wherein a SKey is associated with said smart key.

18. The method of claim 17 wherein said set of rights, said content ID, said device ID, said personal identification code, said transaction key, and said SKey are stored on said license server.

19. The method of claim 18, further including encrypting said content key with said content ID, said device ID, said personal identification code, said transaction key, and said SKey, before said step of transmitting said content key to said rendering device.

20. A method of transmitting a multimedia content file encrypted with a multimedia content key to a rendering device, said rendering device further including a private license key, comprising;
configuring a license server with a set of rights associated with said multimedia content file and with a rendering device user;
requesting that a requested right for said multimedia content file be exercised on said rendering device;
if said requested right is included in said set of rights, encrypting said content key with a public license key, wherein said private license key is configured to decrypt said content key;
if said requested right is not included in said set of rights, billing said rendering device user for said requested right and encrypting said content key with said public license key;
adding a watermark to said multimedia content file;
transmitting said content key to said rendering device;
transmitting said multimedia content file;
decrypting said multimedia content file;
rendering said multimedia content file.

21. A apparatus for transmitting a multimedia content file encrypted with a multimedia content key to a rendering device with a smart key, said rendering device further including a private license key, comprising;
means of configuring a license server with a set of rights associated with said multimedia content file and with a rendering device user;
means of requesting that a requested right for said multimedia content file be exercised on said rendering device;
if said requested right is included in said set of rights, means of encrypting said content key with a public license key, wherein said private license key is configured to decrypt said content key;
if said requested right is not included in said set of rights, means of billing said rendering device user for said requested right and encrypting said content key with said public license key;
means of adding a watermark to said multimedia content file;
means of transmitting said content key to said rendering device;
means of transmitting said multimedia content file;
means of decrypting said multimedia content file;
means of rendering said multimedia content file.

22. The apparatus of claim 21, wherein said set of rights includes one of the right to render, the right to render before an end date, a right to render for a specified number of times, a right to render on a specified number of rendering devices, a right to render in a specified resolution, and a right to render if obtained through a specified distribution channel.

23. The apparatus of claim 22 wherein a SKey is associated with said smart key.

24. The apparatus of claim 23, further including means of encrypting said content key with said SKey.
